(19) United States
(12) Patent Application Publication
(10) Pub. No.: US 2007/0233861 A1
(43) Pub. Date: Oct. 4, 2007

(54) Method and apparatus for implementing SMS SPAM filtering

(75) Inventors: Yigang Cai, Naperville, IL (US); Donna L. McGreal, Chicago, IL (US); Calixto McLean, Blacklick, OH (US); Sanjeev Kumar Singh, New Albany, OH (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(73) Assignee: Lucent Technologies Inc.

(21) Appl. No.: 11/395,786

(22) Filed: Mar. 31, 2006

(51) Int. Cl. G06F 15/173

(52) U.S. Cl. 709/225

(57) ABSTRACT

A method and apparatus for implementing short message service (SMS) SPAM filtering is provided. The embodiments described herein integrate policy management into spam message filtering rules to enhance an SMS anti-spam mechanism.

### BACKGROUND OF THE INVENTION

This invention relates to a method and apparatus for implementing short message service (SMS) SPAM filtering. The embodiments described herein integrate policy management into spam message filtering rules to enhance an SMS anti-spam mechanism.

While the invention is particularly directed to the art of SMS SPAM filtering, and will be thus described with specific reference thereto, it will be appreciated that the invention may have usefulness in other fields and applications. For example, the teachings of the presently described embodiments may be applied to other types of SPAM filtering.

By way of background, with the ever-increasing use of the Internet, it has become relatively easy to send messages to a large number of destinations at little or no cost to the sender. The same is true of messages sent by way of a short message service (SMS) in the wireless network system. In many instances, when the sender is a third party solicitor or marketer, these messages include unsolicited and unwanted content, e.g. SPAM messages. These SPAM messages are a nuisance to the receiver of the message who has to clear the message and determine whether it is of any importance. Further, SMS SPAM is a nuisance to the carrier of the telecommunications network used for transmitting the message. In this regard, it presents a customer relations problem with respect to irate customers who are flooded with spam. It also presents a revenue problem for network providers because these messages, for which there is usually little or no revenue, use a high volume of network resources.

SPAM messages are not merely a nuisance, but are, in many instances, a means for defrauding the recipients of the message by making it apparently attractive for them to provide their credit card information or by urging them to send in a modest amount of money (for “processing expenses” or “taxes”) in the expectation of receiving a very much larger amount. Messages, automatically originated by a computer, for defrauding are frequently sent to a very large number of destinations in the hope that at least some of these destinations will be foolish enough to respond. The problem is serious in the United States but is actually acute in China, Japan, Korea, and, to a lesser extent, in Europe. These latter countries typically have an enormous volume of SMS messages.

There are some vendors developing SMS anti-spam application to solve the problems. One of potential solution is to use policy management to identify SPAM SMS messages.

Policy management is increasingly important in the management of telecommunications networks to enable rich flexibility in determining how resources are deployed and what services can be provided. Much of the existing support for policy in networks has been driven by the need for relatively simple policies that can be enforced in high volume and ultra-short response times.

Standards bodies (IETF, ETSI and 3GPP) have defined policy management requirements for Open Service Access (OSA) since 2002. The latest 3GPP policy management standards (TS29.198-13) can be found from http://www.3gpp.org/ftp/Specs/html-info/29198-13.htm, and the IETF policy management accounting in RFC 3334 hftp://www.rfc-archive.org/qetrfc.php?rfc=3334. The standards provide policy management guidelines for both converged networks and service applications.

Lucent/Bell Labs developed a policy management framework—Vortex Rule Engine (VRE) in 1999. The Vortex Rule Engine provides fast, scalable, carrier-grade support for specifying and executing policies that are expressive enough to support emerging service applications. Two patents relate to the Vortex Rule Engine and associated rule-based language: 1) U.S. Pat. No. 6,424,948, entitled “Declarative Workflow System Supporting Side Effects”, and 2) U.S. Pat. No. 6,499,023, entitled “Data Item Evaluation Based on the Combination of Multiple Factors,” both of which are incorporated herein by reference in their entirety. Both of these patents describe the rule workflow systems and the use of computation rules and a combining policy for a powerful and flexible technique for evaluating data items based on the input conditions.

The Vortex Rule Engine as a computation program has been integrated into many products—platform and service applications—as a policy management tool.

A patent application entitled “Methods and Apparatus for Automated Monitoring and Action Taking based on Decision Support Mechanism” (US Pub. No 20030053615, filed on Dec. 18, 2001) describes an application of the Vortex Rule Engine and decision flows for automated systems, such as e-commerce applications and IVR systems, with a decision support mechanism. This publication is also incorporated herein by referenced in its entirety.

However, no standards documents or existing patents disclose a rule-based service logic for an SMS anti-spam filtering mechanism. Therefore, the presently described embodiments present a unique and first-ever-seen rule based filtering solution in the SMS anti-spam area. This invention uses language adapted to achieve rule-based filtering of SMS messages in the implementation of a Vortex Rule Engine.

### SUMMARY OF THE INVENTION

A method and apparatus for SMS spam filtering are provided.

In one aspect of the invention, a method for filtering short message spam comprises receiving short messages, filtering the short messages based on at least one rule set and processing the short messages based on results of the filtering.

In another aspect of the invention, the filtering comprises buffering the short messages, collecting first data parameters from the SMS messages, collecting second data items, determining a rule set based on the first data and applying the rule set to the short messages to obtain the filtering results.

In another aspect of the invention, the processing comprises determining whether the short messages should be forwarded, deleted or further analyzed based on the filtering results and updating the second data based on the filtering.

In another aspect of the invention, the first data comprises at least one of addresses, timestamps, message types, language and text content.

In another aspect of the invention, the at least one rule set comprises individual filtering rules.

In another aspect of the invention, the at least one rule set comprises rules on order of execution of other rules.

In another aspect of the invention, the at least one rule set comprises rules on conditional execution of selected individual rules.

In another aspect of the invention, the at least one rule set comprises rules on depending between individual rules.

In another aspect of the invention, the at least one rule set comprises rules on making decisions based on results of individual rules.

In another aspect of the invention, the second data comprises as least one of counter values and threshold values.

In another aspect of the invention, the at least one rule set comprises a network address consistency rule.

In another aspect of the invention, the at least one rule set comprises a forbidden/allowed/trusted network rule.

In another aspect of the invention, the at least one rule set comprises network traffic-based rules.

In another aspect of the invention, the at least one rule set comprises per sender rules.

In another aspect of the invention, the at least one rule set comprises identity related rules.

In another aspect of the invention, the at least one rule set comprises suspicious message rules.

In another aspect of the invention, the at least one rule set comprises message content-based rules.

In another aspect of the invention, a system for filtering short message spam comprises means for receiving short messages, means for filtering the short messages based on at least one rule set and means for processing the short messages based on results of the filtering.

In another aspect of the invention, a system comprises a rules engine operative to filter SMS messages based on at least one rule set and a spam filtering application operative to receive the SMS messages prior to filtering and to process the SMS messages based on the results of the filtering.

In another aspect of the invention, the at least one rule set comprises individual filtering rules.

In another aspect of the invention, the at least one rule set comprises rules on order of execution of other rules.

In another aspect of the invention, the at least one rule set comprises rules on conditional execution of selected individual rules.

In another aspect of the invention, the at least one rule set comprises rules on depending between individual rules.

In another aspect of the invention, the at least one rule set comprises rules on making decisions based on results of individual rules.

In another aspect of the invention, the system comprises a rule set editor operative to store, search, modify and view rules and rule sets.

In another aspect of the invention, the rule set editor is remote from the rules engine.

In another aspect of the invention, the system further comprises a rules database operative to store the at least one rule set.

In another aspect of the invention, the at least one rule set comprises a network address consistency rule.

In another aspect of the invention, the at least one rule set comprises a forbidden/allowed/trusted network rule.

In another aspect of the invention, the at least one rule set comprises network traffic-based rules.

In another aspect of the invention, the at least one rule set comprises per sender rules.

In another aspect of the invention, the at least one rule set comprises identity related rules.

In another aspect of the invention, the at least one rule set comprises suspicious message rules.

In another aspect of the invention, the at least one rule set comprises message content-based rules.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a system according to the presently described embodiments;

FIG. 2 is a flow chart illustrating a method according to the presently described embodiments;

FIG. 3 is a flow chart illustrating a method according to the presently described embodiments; and,

FIG. 4 is a flow chart illustrating a method according to the presently described embodiments.

### DETAILED DESCRIPTION OF THE PREFERRED EMBODIMENTS

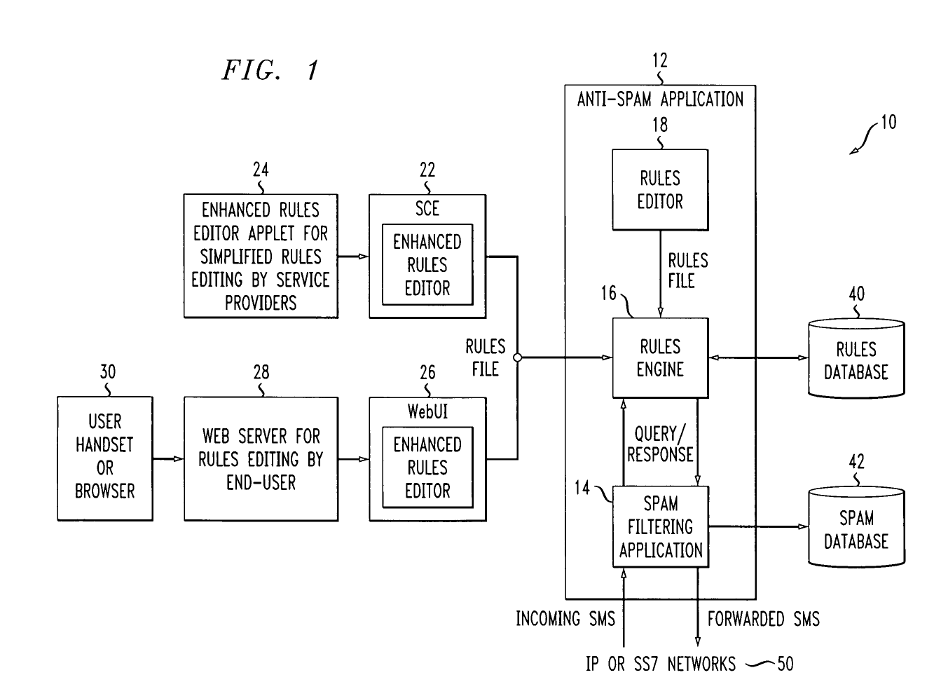

Referring now to the drawings wherein the showings are for purposes of illustrating the preferred embodiments of the invention only and not for purposes of limiting same, FIG. 1 provides a view of a system into which the present invention may be incorporated. As shown, a system 10 includes an anti-spam application in a form of an anti-spam application module 12. The anti-spam application module 12 has included therein a spam filtering application module 14, a rules engine 16 and a rules editor 18.

It should be understood that the rules editor may be replaced by or supplemented by enhanced rules editors such as an enhanced rules editor 22 or an enhanced rules editor 26. Enhanced rules editor 22 may take the form of an SCE that has an enhanced rules editor applet 24 providing input thereto. The enhanced rules editor 26 may take the form of a web user interface (WebUI) that takes its input from a web server 28, that may likewise be in communication with a user handset or browser 30.

Also shown in the system 10 is a rules database 40 and a spam database 42. It should also be understood that the anti-spam application module 12 is, in one form, in communication with a suitable network 50, such an IP network or an SS7 signalling network.

It will be understood that the system 10 may take a variety of forms that will be apparent to those skilled in the art upon reading the present disclosure. For example, the network configuration may differ in different applications and, thus, provide a different environment for the presently described embodiments.

Moreover, the anti-spam application module 12 is illustrated as a software module that may reside in a variety of suitable locations within the network. For example, the module 12 may reside on a mobile switching center (MSC) of a wireless network. Moreover, the anti-spam application module 12 is illustrated as including a spam filtering application 14, rules engine 16 and rules editor 18. While these modules are shown as unique entities in FIG. 1, the functionality described herein may be manifested in a variety of configurations or combinations of elements.

In addition, the presently described embodiments may take the form of suitable software routines that are implemented on appropriate hardware elements. The software routines may reside at suitable centralized locations within the network or may be suitably distributed throughout the network. Different combinations of software routines and/or hardware implementations may also be used to realize the presently described embodiments.

In operation, the presently described embodiments will operate to receive SMS messages, filter the SMS messages based on at least one rule set and then process the SMS messages based on the results of the filtering. This operation will be set forth in greater detail below in connection with FIGS. 2-4.

Referring back now to FIG. 1, the rules engine 16 acts as a Policy Decision Point. It should be understood that it may be embedded within the anti-spam application, as shown, or separated from the application. The rules engine 16 is used to evaluate a set of rules to filter incoming SMS messages. It provides ability to implement/execute logic, referred to as spam filtering rule sets, for filtering each message type. It also passes the filtering result back to the application 14. The spam filtering logic is configured within rule sets which is written by rules engine editor 18 and saved in the database 40. The rules engine 16 will call the rule sets when executing spam filtering.

In one form, the rule sets stored in the database 40 are specified as:
Individual filtering Rules (e.g., message volume check)
Rules on order of execution of the filtering rules (e.g., check valid sender first)
Rules on conditional execution of specific individual rules (e.g., check for valid IMSI only if the IMSI is present in the message for messages with optional IMSI)
Rules on dependency between the individual filtering rules (e.g., ignore rest of the checks if receiver is not Home subscriber)
Rules on ability to make decisions based on the result of the individual rule sets (e.g., decide on first violation or collective decision based on set of results)

The service provider or subscriber can set rule sets for each supported message type.

The rules editor 18 supports a rules-editing facility that allows a user to create new spam filtering rule sets or modify existing rule sets, and save rule sets in the rule database 40. The rules editor 18 can be accessed remotely via a web user interface by either a service provider representative or even a subscriber (by internet or handset).

The rules database 40 stores the files of rule sets and other relevant data for spam filtering. The rules files and data can be defined at either service provider or subscriber levels. The file and data can be viewed, searched, and modified with privilege of access.

The spam filtering application 14 acts as a policy enforcement and execution point and processes incoming SMS messages, sends queries to the rule engine for real time spam filtering based on spam filtering rule sets stored in the rules database, and executes the processing of post-filtering SMS message based on returned results from the rule engine. Prior to calling or applying the appropriate rule set, the application will buffer incoming SMS messages, collect SMS parameters (such as addresses, timestamps, message types, language, text content) for input to the rule engine, collect other data (such as counter value, counter type, adjacency factor, threshold value, etc.) for input to the rule engine, determine the rule set to call based on message types, and call and apply the function of the rule engine with all necessary input data. After calling the appropriate rule set, the application will receive the result from the rule engine, process the SMS and update the filtering data (counter values, threshold value, etc.). It will be understood that processing the SMS comprises forwarding GOOD message to the destination network, deleting spam messages and sending warning to the sending network, and/or conducting further analysis for suspicious messages.

The basic rules to be applied to realize the contemplated system may vary from application to application. However, in one form, the system includes a Network Address Consistency rule. In this regard, the Anti-Spam application, e.g., the anti-spam application module 12 allows an operator to configure the number of digits in two addresses (digits), starting from left, that must be checked for network address consistency. Two addresses specified at different levels of the mobile terminated SMS message, MAP (Mobile Application Part) and SCCP (SS7 Signaling Connection Control Part), must be consistent in terms of country code and national destination code.

In at least one form, the Anti-Spam application allows an operator to configure whether a particular network is forbidden, allowed or trusted to send messages, e.g. a Forbidden/Allowed/Trusted Network Rule. A specific network is identified by a prefix. A wild card is used to identify other network addresses not specifically configured otherwise by the operator. It is allowed to specify overlapping prefix such as 123 and 12345 as separate data records in which case the most specific prefix (longest matching prefix) is given preference.

The presently described embodiments also allow for network based traffic rules. One such rule is a Message Volume Threshold Rule—Per Sending Network. In relation to this rule, the anti-Spam application allows an operator to configure the volume thresholds for each message type per sending network (one network group).

The Anti-Spam application also provides a utility function to check whether the number of specified message types received from the PLMN or IP domain, to which the specified sending party belongs, during the configured interval, has exceeded any of the volume based thresholds configured for the specified message type for the network group to which the sending party belongs.

In this regard, the following is supported:

This evaluates threshold checks for all the active threshold types configured in the application for the specified message type and the network group to which the sending party belongs.

If the required thresholds to perform this check is not configured, the Anti-Spam application assumes there were no violations.

It should be understood that the configured interval is determined based on the threshold types that are configured, e.g., if hourly and monthly thresholds are configured for a message, the hourly and monthly count of the message shall be checked for threshold violation. Further, for SS7 network, the sending party would belong to a PLMN (Public Land Mobile Network). Also, for SMPP (Short Message Point to Point Protocol) messages, the sending party would belong to a domain.

Another network traffic based rule is a Message Volume Threshold Rule—Across all Networks. Under this rule, the Anti-Spam application allows an operator to configure the volume thresholds for each message type across network groups. The Anti-Spam application provides a utility function to determine whether the number of specified message types received during a configured interval has exceeded any of the volume based thresholds configured for the specified message type across the network groups. In this regard, the following is supported:

This evaluates threshold checks for all the Active threshold types configured in the application for the specified message type across the network groups.

The check for IP (Internet Protocol) based SMEs (Short Message Entities) (SMPP_SUBMIT_SM messages) is done against the data maintained for the IP domains.

The check for SS7 based SMSEs (Short Message Service Entities) (FW_SMS_MO, SRI_SMS, FW_SMS_MT, and FW_SMS) is done against the data maintained for the SS7 PLMN

The result of the check indicates all the thresholds that were violated, if any.

If the required thresholds to perform this check are not configured, the Anti-Spam application assumes there were no violations.

It should be understood that the configured interval is determined based on the threshold types that are configured, e.g., if hourly and monthly thresholds are configured for a message, the hourly and monthly count of the message shall be checked for threshold violation. Also, this would essentially check across all group IDs for which a threshold is configured. But, only those thresholds for the message type being checked would be used. So, there is no need to separate the group IDs for SS7 and IP network.

A third network traffic based rule is the Called Party Address Adjacency Rule. Using this rule, the Anti-Spam application allows an operator to configure the adjacency factor and interval for the adjacency check for called party addresses for each message type. The Anti-Spam application provides a utility function to check whether the number of specified message type sent to a range of called party address, to which the called party address for the specified message type belongs, during the configured interval has exceeded the thresholds configured for the specified message type. If the required threshold to perform this check is not configured, the Anti-Spam application assumes there were no violations. The range of the address is simply identified by the prefix of the address, e.g., prefix 1614860 would indicate the range as 1614860-0000 thru 1614860-9999. Any number with the prefix 1614860 would be considered to belong to this range and would contribute to the count for the prefix 1614860.

Another type of rule to be implemented in one form is a Per Sender Rule. These Per Sender Rules may take a variety of forms, but one example is a Forbidden/Allowed/Trusted Rule. Under this rule, the forbidden/trusted rule is provided on a per SME/ESME basis. The Anti-Spam application allows an operator to configure whether a particular sender is forbidden, allowed or trusted to send messages. An SME is identified by an address, and an ESME (External Short Message Entity) is identified by the System_Id in SMPP protocol. Thus, these addresses can be MSISDN (Mobile Subscriber ISDN Number), IMSI (International Mobile Station Identity), System ID (identification) assigned to an ESME, or the SME addresses using the services of an SMPP ESME.

Another form of a Per Sender Rule is a Message Volume Threshold Rule. In this scenario, the Anti-Spam application allows an operator to configure the volume thresholds for each message type. It shall be possible to configure thresholds for a specific SME, a range of SMEs (only for those that are identified by MSISDN or IMSI), or an SMPP ESME System Id.

Still set of rules may relate to Sender/Receiver Identity Rules. One such rule is a Roaming Validity Rule. In this situation, the roaming validity check is to determine if the mobile originated call received from a foreign network is actually from the network where the subscriber is currently roaming in. The current location of a roaming subscriber is maintained in HLR (Home Location Register) in the home network. This is the VLR (Visiting Location Register) address or the MSC (Mobile Switching Center) address for the current location of the subscriber. The called party address global title in the SCCP part of the mobile originated message is expected to contain either the VLR address or the MSC address for the current subscriber location. So, the application needs to verify whether the VLR address or MSC address in the mobile originated message is same as the current VLR address or MSC address respectively for the subscriber. The Anti-Spam application provides a utility function to check whether the specified VLR or MSC address, derived from the mobile originated message, is same as the current VLR or MSC address respectively for the subscriber in the HLR. In order to support this, the application shall do the following:

Query the VLR or MSC address for the subscriber from the HLR using the configured operation. The VLR address shall be queried if the incoming message contained the VLR address but the MSC address shall be queried if the incoming message carried the MSC address.

Verify if the specified VLR or MSC address is same as that retrieved from the HLR and return the result.

A Home Subscriber Rule may also be implemented. Here, a home subscriber check in the anti-spam application is used to determine if a specified subscriber address belongs to the home network. This can be used to check if the terminating message is for home subscriber or not. If it is not for a home network subscriber, the mobile terminated message is not considered suspect and no further checks are required for this message. The anti-spam application shall provide a utility function to check whether the specified IMSI or LMSI for a subscriber belongs to the home network. In order to support this, the application does the following:

Determine if the network address configured for the home network is a prefix in the specified IMSI or LMSI (Local Mobile Station Identity).

If a prefix match is found, the subscriber is considered to belong to the home network. Otherwise the subscriber belongs to another network.

A Suspicious SRI_SMS Rule may also be implemented. In this regard, a suspicious SRI_SMS check in the anti-spam application is used to determine if the SRI_SMS message corresponding to the mobile terminated message being checked for spam. If the corresponding SRI_SMS message was suspicious, the application can be configured to respond with its own global title address in place of the MSC's global title address that is returned by the HLR. So, if any mobile terminated messages arrive to the anti-spam application with Anti-Spam applications Global Title in the called party address global title, this would indicate that the corresponding SRI_SMS was suspicious.

The anti-spam application provides a utility function to check whether the specified global title address, derived from the called party address global title in the SCCP part of the message, is same as that assigned to the Anti-Spam application.

Another type of rules that may be implemented is referred to as Message Content Based Rules. Like the other types, Message Content Based Rules may take a variety of forms. In one form, the Anti-Spam application shall execute pattern matching rules only if the pattern matching is enabled for the PLMN (Public Land Mobile Network) or ESME System ID from which the message was received. If this check is not enabled, the pattern matching rule in a rule set shall consider that the message text did not match any pattern.

If there is an exact pattern, the Anti-Spam application shall provide a utility function to verify if any of the patterns in the current pattern list, for exact pattern match maintained in the application, has an exact match with any part of the text in the message being checked. If any of the patterns appears in the text, the message shall be considered to match the known patterns. This shall be supported for all encoded languages.

If there is a variable pattern, the anti-spam application shall provide a utility function to verify if any of the patterns in the current pattern list, for variable pattern match maintained in the application, as specified in section 4.2.3, has a match with any part of the text in the message being checked. If any of the variable pattern appears in the text, the message shall be considered to match the known variable patterns. The following is supported to match for variable patterns:

Any spaces or special characters, as configured by the operator shall be ignored in the text of

Matching shall be case insensitive

This is supported for all encoded languages.

Another message content based rule is the Invalid Message Content Rule. Under this rule, the anti-spam application provides a utility function to verify if any missing content or invalid content including header and text within the messages.

With reference now to FIG. 2, a flow chart illustrating an overall method according to the presently described embodiments is illustrated.

As shown, the method 200 includes receiving SMS messages at the Anti-Spam application module 12 (at 202). The messages are then filtered based on at least one rule set stored in the rules database 40 (at 204). Last, the messages are processed based on the results of the filtering (at 206).

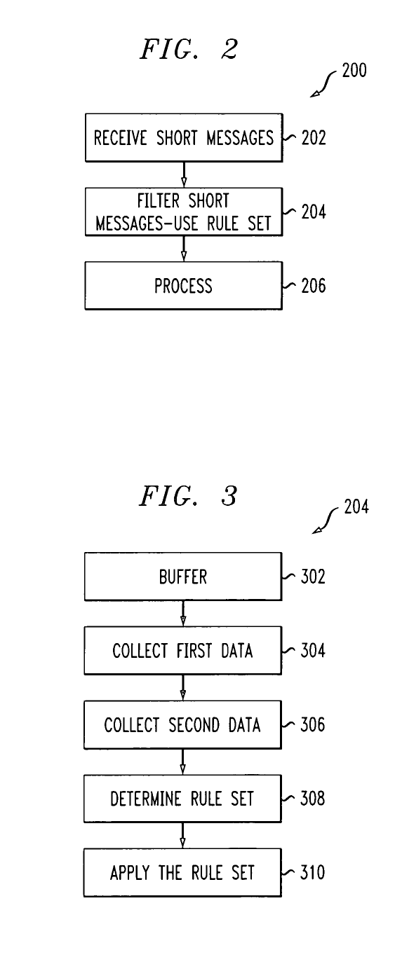

More particularly, with reference now to FIG. 3, the filtering step 204 is illustrated in greater detail. The filtering 204 is, in at least one form, initiated by buffering the SMS messages that are received at 202 (at 302). Next, data is collected regarding parameters for the SMS messages (at 304). This data includes information such as addresses, timestamps, message types, language and text content. These parameters are useful as input for the rule engine 16.

Next, other data is collected (at 306). This data includes counter values, counter types, adjacency factors, threshold values, . . . etc. This is also used as input for the rule engine 16. A determination of the rule set that will be used is then made based on the message type (at 308). Last, the rule set is applied to the SMS messages to obtain the filtering results (at 310).

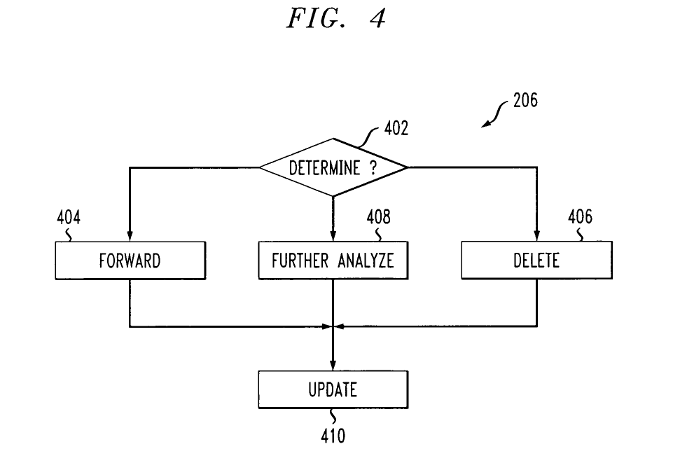

With reference now to FIG. 4, the processing step 206 is explained, in at least one form, in greater detail. As shown, the processing step 206 includes determining whether the SMS messages should be forwarded, deleted or further analyzed based on the filtering results (at 402). Next, the filtering data such as the counter values, threshold values, . . . etc. are updated (at 404).

Implementation of the presently described embodiments may result in implementation of a variety of different rule sets. Examples of such rule sets are set forth below.

### EXAMPLE 1

### Default SRI_SMS Rule Set

Individual Rules Executed in Order,

Network Address Consistency Rule (SUSPECT)

Forbidden/Trusted Network Rule (SPAM/GOOD)

Volume Threshold Rule—Per Sending Network (SUSPECT)

Volume Threshold Rule—Across all Networks (SUSPECT)

Called Party Address Adjacency Rule (SUSPECT)

If any of the above rules is violated, the message is marked as indicated above and no further rule is evaluated. If there is an application error evaluating a rule, the error is logged but the rule would be ignored for spam filtering. Execution would continue with the next rule in above order. If none of these rules are violated, the message is marked GOOD. Note that message can be marked GOOD also when it is from a trusted source.

### EXAMPLE 2

### Default FW_SMS_MT Rule Set

Individual Rules Executed in Order,

Suspicious SRI_SMS Rule (SUSPECT)

Home Subscriber Rule (GOOD)

Invalid Message Content Rule (SPAM)

Network Address Consistency Rule (SUSPECT)

Forbidden/Trusted Network Rule (SPAM/GOOD)

Forbidden/Trusted Sender (SME) Rule (SPAM/GOOD)

Volume Threshold Rule—Per Sender (SME) (SPAM)

Volume Threshold Rule—Per Sending Network (SUSPECT)

Volume Threshold Rule—Across all Networks (SUSPECT)

Called Party Address Adjacency Rule (SUSPECT)

Pattern Matching Rule (SUSPECT)

If any of the above rules is violated, the message is marked as indicated above and no further rule is evaluated. If there is an application error evaluating a rule, the error shall be logged but the rule would be ignored for spam filtering. Execution would continue with the next rule in above order. If none of these rules are violated, the message is marked GOOD. Note that message can be marked GOOD also when it is from a trusted source.

### EXAMPLE 3

### Default FW_SMS_MO Rule Set

Individual Rules Executed in Order,

Home Subscriber Rule (SPAM)

Forbidden/Trusted Network Rule (SPAM/GOOD)

Forbidden/Trusted Sender (SME) Rule (SPAM/GOOD)

Roaming Validity Rule (SPAM)

Invalid Message Content Rule (SPAM)

Volume Threshold Rule—Per Sender (SME) (SPAM)

Volume Threshold Rule—Per Sending Network (SUSPECT)

Volume Threshold Rule—Across all Networks (SUSPECT)

Destination SME Adjacency Rule (SUSPECT)

Pattern Matching Rule (SUSPECT)

If any of the above rules is violated, the message is marked as indicated above and no further rule is evaluated. If there is an application error evaluating a rule, the error shall be logged but the rule would be ignored for spam filtering. Execution would continue with the next rule in above order. If none of these rules are violated, the message is marked GOOD. Note that message can be marked GOOD also when it is from a trusted source.

### EXAMPLE 4

### Default SMPP_SUBMIT_SM Rule Set

Individual Rules Executed in Order,

Forbidden/Trusted Sender's Domain Rule (SPAM/GOOD)

Forbidden/Trusted Sender (SME) Rule (SPAM/GOOD)

Forbidden/Trusted ESME Rule (SPAM/GOOD)

Roaming Validity Rule (SPAM)

Invalid Message Content Rule (SPAM)

Volume Threshold Rule—Per Sender (SME) (SPAM)

Volume Threshold Rule—Per Sending ESME (SUSPECT)

Volume Threshold Rule—Per Sending Domain (SUSPECT)

Pattern Matching Rule (SUSPECT)

If any of the above rules is violated, the message is marked as indicated above and no further rule is evaluated. If there is an application error evaluating a rule, the error shall be logged but the rule would be ignored for spam filtering. Execution would continue with the next rule in above order. If none of these rules are violated, the message is marked GOOD. Note that message can be marked GOOD also when it is from a trusted source.

For completion, acronyms are identified below:
ESME External Short Message Entity
HLR Home Location Register
IMSI International Mobile Station Identity
IP Internet Protocol
LMSI Local Mobile Station Identity
MAP Mobile Application Part
MSC Mobile Switching Center
MSISDN Mobile Subscriber ISDN Number
PLMN Public Land Mobile Network
SCCP SS7 Signaling Connection Control Part
SCE Service Creation Environment
SME Short Message Entity
SMPP Short Message Point to Point Protocol
SMSE Short Message Service Entity
SMS Short Message Service
SRI Send Routing Information
SS7 Signaling System number 7
UI User Interface
VLR Visiting Location Register
VRE Vortex Rules Engine

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for filtering short message spam, the method comprising:
receiving short messages;
filtering the short messages based on at least one rule set; and,
processing the short messages based on results of the filtering.

2. A method as set forth in claim 1 wherein the filtering comprises:
buffering the short messages;
collecting first data parameters from the SMS messages;
collecting second data items;
determining a rule set based on the first data; and,
applying the rule set to the short messages to obtain the filtering results.

3. The method as set forth in claim 2 wherein the processing comprises:
determining whether the short messages should be forwarded, deleted or further analyzed based on the filtering results; and,
updating the second data based on the filtering.

4. The method as set forth in claim 2 wherein the first data comprises at least one of addresses, timestamps, message types, language and text content.

5. The method as set forth in claim 2.wherein the second data comprises as least one of counter values and threshold values.

6. The method as set forth in claim 1 wherein the at least one rule set comprises individual filtering rules.

7. The method as set forth in claim 1 wherein the at least one rule set comprises rules on order of execution of other rules.

8. The method as set forth in claim 1 wherein the at least one rule set comprises rules on conditional execution of selected individual rules.

9. The method as set forth in claim 1 wherein the at least one rule set comprises rules on depending between individual rules.

10. The method as set forth in claim 1 wherein the at least one rule set comprises rules on making decisions based on results of individual rules.

11. The method as set forth in claim 1 wherein the at least one rule set comprises a network address consistency rule.

12. The method as set forth in claim 1 wherein the at least one rule set comprises a forbidden/allowed/trusted network rule.

13. The method as set forth in claim 1 wherein the at least one rule set comprises network traffic-based rules.

14. The method as set forth in claim 1 wherein the at least one rule set comprises per sender rules.

15. The method as set forth in claim 1 wherein the at least one rule set comprises identity related rules.

16. The method as set forth in claim 1 wherein the at least one rule set comprises suspicious message rules.

17. The method as set forth in claim 1 wherein the at least one rule set comprises message content-based rules.

18. A system for filtering short message spam, the system comprising:
means for receiving short messages;
means for filtering the short messages based on at least one rule set; and,
means for processing the short messages based on results of the filtering.

19. A system for filtering short message spam, the system comprising:
a rules engine operative to filter SMS messages based on at least one rule set; and,
a spam filtering application operative to receive the SMS messages prior to filtering and to process the SMS messages based on the results of the filtering.

20. The system as set forth in claim 19 wherein the at least one rule set comprises individual filtering rules.

21. The system as set forth in claim 19 wherein the at least one rule set comprises rules on order of execution of other rules.

22. The system as set forth in claim 19 wherein the at least one rule set comprises rules on conditional execution of selected individual rules.

23. The system as set forth in claim 19 wherein the at least one rule set comprises rules on depending between individual rules.

24. The system as set forth in claim 19 wherein the at least one rule set comprises rules on making decisions based on results of individual rules.

25. The system as set forth in claim 19 further comprising a rule set editor operative to store, view, search and modify rules and rule sets.

26. The system as set forth in claim 25 wherein the rule set editor is remote from the rules engine.

27. The system as set forth in claim 19 further comprising a rules database operative to store the at least one rule set.

28. The system as set forth in claim 19 wherein the at least one rule set comprises a network address consistency rule.

29. The system as set forth in claim 19 wherein the at least one rule set comprises a forbidden/allowed/trusted network rule.

30. The system as set forth in claim 19 wherein the at least one rule set comprises network traffic-based rules.

31. The system as set forth in claim 19 wherein the at least one rule set comprises per sender rules.

32. The system as set forth in claim 19 wherein the at least one rule set comprises identity related rules.

33. The system as set forth in claim 19 wherein the at least one rule set comprises suspicious message rules.

34. The system as set forth in claim 19 wherein the at least one rule set comprises message content-based rules.
